(19) United States
(12) Patent Application Publication
(10) Pub. No.: US 2018/0173003 A1
(43) Pub. Date: Jun. 21, 2018

(54) SPLITTER AND STEREOSCOPIC DISPLAY PANEL

(71) Applicant: Wuhan China Star Oploelectronics Technology Co., L, Wuhan, Hubei (CN)

(72) Inventor: Chang XIE, Shenzhen, Guangdong (CN)

(73) Assignee: Wuhan China Star Optoelectronics Technology Co., L td., Wuhan, Hubei (CN)

(21) Appl. No.: 15/113,414

(22) PCT Filed: Jun. 29, 2016
(86) PCT No.: PCT/CN2016/087664

§ 371 Date: Jul. 21, 2016

(30) Foreign Application Priority Data
Jun. 12, 2016 (CN) 201610410023.9

(51) Int. Cl. G02B 27/10; G02B 27/22

(52) U.S. Cl. CPC G02B 27/10; H04N 13/04; G02B 27/22

(57) ABSTRACT

The present application discloses a splitter and a stereoscopic display panel. The splitter is applied to a stereoscopic display panel, the splitter including a plurality of light shielding regions and a plurality of light transmitting region; the plurality of the light shielding regions is extending in the same direction, and the plurality of light shielding region are disposed in intervals, the light shielding region is jagged the and the space between the two adjacent light shielding region is defined as the light transmitting region. The splitter can reduce the producing the viewing of the space moire pattern, thereby increasing stereoscopic display quality.

### CROSS REFERENCE

This application claims the priority of Chinese Patent Application No. 201610410023.9, entitled “SPLITTER AND STEREOSCOPIC DISPLAY PANEL”, filed on Jun. 12, 2016, the disclosure of which is incorporated herein by reference in its entirety.

### FIELD OF THE INVENTION

The present application relates to a stereoscopic display technology field, and more particularly to a splitter and a stereoscopic display panel.

### BACKGROUND OF THE INVENTION

By eliminating the need to wear conventional glasses, the naked eye stereoscopic display technology is closer to people's daily habits and become the development trend of stereoscopic display technology. Naked eye stereoscopic display panel includes a display panel 1 and a splitter 2. Wherein, the liquid crystal display panel or a plasma display panel is mainly used as a display panel. The splitter is mainly used a parallax barriers grating and a transmitting grating. For the display panel, both the liquid crystal display panel or a plasma display panel, the pixel cells are arranged at equal intervals, both in the horizontal and vertical directions, respectively, opaque stripes of the spacing between each of the pixel unit are formed in the horizontal and vertical directions, i.e., the black matrix. For either the splitter, parallax barrier grating or transmitting grating, are optical device with stripe shapes arranged at equal intervals, and has similar spatial periodic structure with the pixel structure of the display panel. Therefore, during the display of the naked eye stereoscopic display panel, the display panel and splitter is easy to have the optical interference resulting space moire pattern in the viewing area, as illustrated in FIG. 1, thus affecting the stereoscopic display.

### SUMMARY OF THE INVENTION

The present application discloses a splitter, the splitter is applied to a stereoscopic display panel, wherein the splitter including a plurality of light shielding regions and a plurality of light transmitting region; the plurality of the light shielding regions is extending in the same direction, and the plurality of light shielding region are disposed in intervals, the light shielding region is jagged the and the space between the two adjacent light shielding region is defined as the light transmitting region.

Wherein the splitter is rectangular, the plurality of the light shielding regions are all extending parallel to the direction of one of the diagonal of the rectangle.

Wherein the light shielding region including a plurality of jagged unit, the jagged unit including a first portion and second portion; the first portion are extending along a first direction, the second portion are extending along the second direction, and one terminal of the second portion is connected to one terminal of the first portion; and the angle between the first portion and the second portion is 90°; wherein, the first direction is perpendicular to the second direction.

Wherein the width of the light shielding region is defined as the size of the first portion along the second direction; and the widths of the two adjacent light shielding regions are different.

Wherein the size of the first portion along the second direction is equal to the size of the second portion along the first direction dimension.

The light shielding regions of the splitter in the present application is disposed in jagged, the plurality of light shielding region are disposed in intervals, and the space between the two adjacent light shielding region is defined as the light transmitting region. Therefore, the jagged irregular grating structure of the splitter of the present application, and having larger difference between the conventional grating structure with a stripe shape and arranged at equal intervals. Comparing to the conventional grating structure with a stripe shape and arranged at equal intervals, when display a stereoscopic image by the coupling of the splitter and the display panel with the grating structure with a stripe shape and arranged at equal intervals, the optical interference is small, thus reducing the producing the viewing of the space moire pattern, thereby increasing display quality of the stereoscopic display.

A stereoscopic display is also provided in the present application, the stereoscopic display panel includes a splitter, the splitter including a plurality of light shielding regions and a plurality of light transmitting region; the plurality of the light shielding regions is extending in the same direction, and the plurality of light shielding region are disposed in intervals, the light shielding region is jagged the and the space between the two adjacent light shielding region is defined as the light transmitting region.

Wherein the splitter is rectangular, the plurality of the light shielding regions are all extending parallel to the direction of one of the diagonal of the rectangle.

Wherein the light shielding region including a plurality of jagged unit, the jagged unit including a first portion and second portion; the first portion are extending along a first direction, the second portion are extending along the second direction, and one terminal of the second portion is connected to one terminal of the first portion; and the angle between the first portion and the second portion is 90°; wherein, the first direction is perpendicular to the second direction.

Wherein the width of the light shielding region is defined as the size of the first portion along the second direction; and the widths of the two adjacent light shielding regions are different.

Wherein the size of the first portion along the second direction is equal to the size of the second portion along the first direction dimension.

### BRIEF DESCRIPTION OF THE DRAWINGS

In order to more clearly illustrate the embodiments of the present application or prior art, the following figures will be described in the embodiments are briefly introduced. It is obvious that the drawings are merely some embodiments of the present application, those of ordinary skill in this field can obtain other figures according to these figures without paying the premise.

FIG. 1 illustrates a schematic diagram of the moire pattern generated from the display panel and a parallax barrier splitter of the conventional naked eye stereoscopic display during display;

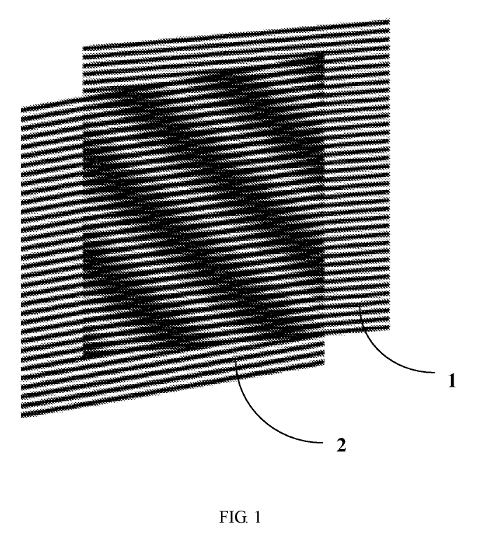

FIG. 2 illustrates a schematic structure of the splitter of the preferred embodiment of the present application; and

FIG. 3 illustrates a schematic structure of the stereoscopic display of the preferred embodiment of the present application.

### DETAILED DESCRIPTION OF PREFERRED EMBODIMENTS

Embodiments of the present application are described in detail with the technical matters, structural features, achieved objects, and effects with reference to the accompanying drawings as follows. It is clear that the described embodiments are part of embodiments of the present application, but not all embodiments. Based on the embodiments of the present application, all other embodiments to those of ordinary skill in the premise of no creative efforts obtained should be considered within the scope of protection of the present application.

Specifically, the terminologies in the embodiments of the present application are merely for describing the purpose of the certain embodiment, but not to limit the invention. Examples and the claims be implemented in the present application requires the use of the singular form of the book “an”, “the” and “the” are intend to include most forms unless the context clearly dictates otherwise. It should also be understood that the terminology used herein that “and/or” means and includes any or all possible combinations of one or more of the associated listed items.

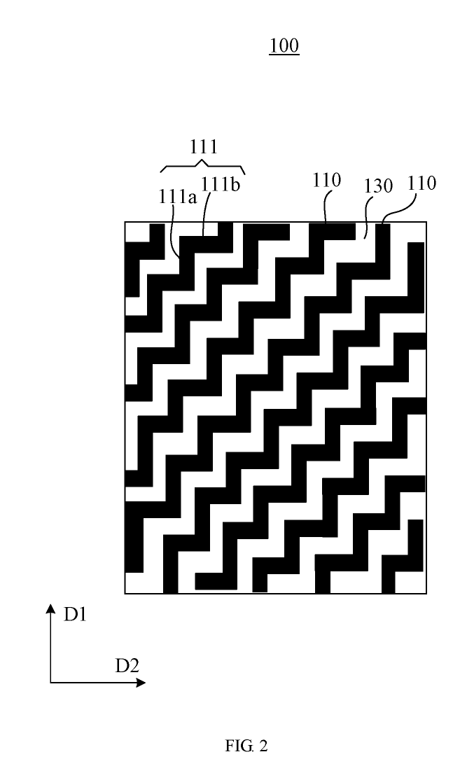

Refer to FIG. 2, FIG. 2 illustrates a schematic structure of the splitter of the preferred embodiment of the present application. The splitter 100 is applied to a stereoscopic display panel; the splitter 100 is a parallax barrier grating structure. The splitter 100 includes a plurality of light shielding regions 110 and a plurality of light transmitting region 130. The plurality of the light shielding regions 110 is extending in the same direction, and the plurality of light shielding region 110 are disposed in intervals, the light shielding region 110 is jagged the and space between the two adjacent light shielding region is defined as the light transmitting region 130.

When the light emitting to the light shielding region 110 of the splitter 100, the light cannot pass through the light shielding region 110, or the transmittance of the light pass through the light shielding region 110 is less than or equal to a first light transmitting threshold. When the transmittance of the light pass through the light shielding region 110 is less than or equal to a first light transmitting threshold, the transmittance of the light pass through the light shielding region 110 is small, it is considered that the light cannot pass the light shading region 110. For example, in one embodiment, the first light transmitting threshold can be 5%. When the light emitting to the light transmitting region 130 of the splitter 100, the light can transmit the light transmitting region 130, or the transmittance of the light pass through the light transmitting region 130 is more than or equal to a second light transmitting threshold, the transmittance of the light pass through the light transmitting region 130 is large, it is considered that the light can pass the light transmitting region 130. For example, in one embodiment, the second predetermined threshold is 95%.

In one embodiment, the splitter 100 is rectangular, the plurality of the light shielding regions 110 are all extending parallel to the direction of one of the diagonal of the rectangle.

The light shielding region 110 includes a plurality of jagged unit 111, the jagged unit 111 includes a first portion 111a and second portion 111b. The first portion 111a are extending along a first direction D1, the second portion 111b are extending along the second direction D2, and one terminal of the second portion 111b is connected to one terminal of the first portion 111a, and the angle between the first portion 111a and the second portion 111b is 90°. Wherein, the first direction D1 is perpendicular to the second direction D2.

In the present embodiment, the first direction D1 is the Y-axis direction, the second direction D2 is the X-axis direction. It can be understood that, in other embodiments, the first direction D1 is the X-axis direction, the second direction D2 is the Y-axis direction. Or, in other embodiments, the first direction D1 and the second direction D2 is not limited to the X-axis and Y-axis direction, as long as the first direction D1 is perpendicular to the second direction D2.

In the present embodiment, the size of the first portion 111a along the second direction D2 is equal to the size of the second portion 111b along the first direction dimension D1.

The width of the light shielding region 110 is defined as the size of the first portion 111a along the second direction D2, and the widths of the two adjacent light shielding regions 110 are different.

The light transmitting region 130 of the splitter 100 of the present application is disposed as jagged, the plurality of the light shielding regions 110 are in intervals, and the and space defined between two adjacent light shielding region 110 is the light transmitting region 130. Thus, jagged irregular grating structure is formed in the splitter 100 of the present application, and having larger difference between the conventional grating structure with a stripe shape and arranged at equal intervals. Comparing to the conventional grating structure with a stripe shape and arranged at equal intervals, when display a stereoscopic image by the coupling of the splitter 100 and the display panel with the grating structure with a stripe shape and arranged at equal intervals, the optical interference is small, thus reducing the producing the viewing of the space moire pattern, thereby increasing display quality of the stereoscopic display.

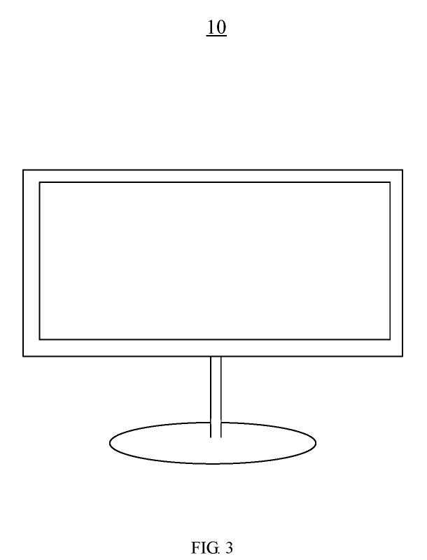

Referring to FIG. 3, FIG. 3 illustrates a schematic structure of the stereoscopic display of the preferred embodiment of the present application. The stereoscopic display panel 10 can be, but is not limited to a liquid crystal display panel or a plasma display panel. The stereoscopic display panel 10 includes a splitter 100, the splitter 100 is as the embodiments described above, are not discussed here. The stereoscopic display panel 10 further includes a display panel (not shown), the display panel further includes a color filter substrate (not shown), the color filter substrate includes a light transmitting region to transmitting light and a composition of the black matrix to shield light, the color filter substrate can formed a grating structure with a stripe shape and arranged at equal intervals. The splitter 100 and the color filter substrate cooperate to produce a stereoscopic display.

Above are embodiments of the present application, which does not limit the scope of the present application. Any modifications, equivalent replacements or improvements within the spirit and principles of the embodiment described above should be covered by the protected scope of the invention.

What is claimed is:

1. A splitter is applied to a stereoscopic display panel, wherein the splitter comprising a plurality of light shielding regions and a plurality of light transmitting region; the plurality of the light shielding regions is extending in the same direction, and the plurality of light shielding region are disposed in intervals, the light shielding region is jagged and the space between the two adjacent light shielding region is defined as the light transmitting region.

2. The splitter according to claim 1, wherein the splitter is rectangular, the plurality of the light shielding regions are all extending parallel to the direction of one of the diagonal of the rectangle.

3. The splitter according to claim 1, wherein the light shielding region comprising a plurality of jagged unit, the jagged unit comprising a first portion and second portion; the first portion are extending along a first direction, the second portion are extending along the second direction, and one terminal of the second portion is connected to one terminal of the first portion; and the angle between the first portion and the second portion is 90°; wherein, the first direction is perpendicular to the second direction.

4. The splitter according to claim 3, wherein the width of the light shielding region is defined as the size of the first portion along the second direction; and the widths of the two adjacent light shielding regions are different.

5. The splitter according to claim 3, wherein the size of the first portion along the second direction is equal to the size of the second portion along the first direction dimension.

6. A stereoscopic display panel, wherein the stereoscopic display panel comprising a splitter, the splitter comprising a plurality of light shielding regions and a plurality of light transmitting region; the plurality of the light shielding regions is extending in the same direction, and the plurality of light shielding region are disposed in intervals, the light shielding region is jagged and the space between the two adjacent light shielding region is defined as the light transmitting region.

7. The stereoscopic display panel according to claim 6, wherein the splitter is rectangular, the plurality of the light shielding regions are all extending parallel to the direction of one of the diagonal of the rectangle.

8. The stereoscopic display panel according to claim 6, wherein the light shielding region comprising a plurality of jagged unit, the jagged unit comprising a first portion and second portion; the first portion are extending along a first direction, the second portion are extending along the second direction, and one terminal of the second portion is connected to one terminal of the first portion; and the angle between the first portion and the second portion is 90°; wherein, the first direction is perpendicular to the second direction.

9. The stereoscopic display panel according to claim 8, wherein the width of the light shielding region is defined as the size of the first portion along the second direction; and the widths of the two adjacent light shielding regions are different.

10. The stereoscopic display panel according to claim 8, wherein the size of the first portion along the second direction is equal to the size of the second portion along the first direction dimension.
